(19) United States
(12) Patent Application Publication
(10) Pub. No.: US 2026/0185194 A1
(43) Pub. Date: Jul. 2, 2026

(54) MAGNETIC POWDER, COMPOUND FOR BONDED MAGNET, AND BONDED MAGNET

(71) Applicant: Daido Steel Co., Ltd., Aichi (JP)

(72) Inventors: Mayu KIKUCHI, Nagoya (JP); Michihide NAKAMURA, Nagoya (JP); Yasuhiro UNE, Nagoya (JP)

(21) Appl. No.: 19/431,034

(22) Filed: Dec. 23, 2025

(30) Foreign Application Priority Data
Dec. 26, 2024 (JP) 2024-230675
Dec. 15, 2025 (JP) 2025-249708

(51) Int. Cl. C22C 38/00; C22C 38/14; H01F 1/22

(52) U.S. Cl. CPC C22C 38/005; C22C 38/001; C22C 38/002; C22C 38/14; H01F 1/22

(57) ABSTRACT

A magnetic powder contains Sm, Zr, Fe, B, and N. An atomic ratio of a content of Zr to a sum of a content of Sm and the content of Zr is greater than 0.10 and smaller than 0.30. A content of B is greater than 0.0 atom % and smaller than 0.4 atom %.

### CROSS-REFERENCE TO RELATED APPLICATION(S)

The present application claims priority to and incorporates by reference the entire contents of Japanese Patent Application No. 2024-230675 filed in Japan on Dec. 26, 2024, and Japanese Patent Application No. 2025-249708 filed in Japan on Dec. 15, 2025

### BACKGROUND OF THE INVENTION

### 1. Field of the Invention

The present invention relates to a magnetic powder, a compound for a bonded magnet, and a bonded magnet.

### 2. Description of the Related Art

JP 2002-57017 A discloses an isotropic Sm—Fe—N— based magnetic powder having a composition of SmₓFe₁₀₀₋ₓ₋ᵥNᵥ (7≤x≤12 and 0.5≤v≤20), exhibiting a TbCu₇-type crystal structure, and having a flake thickness of 10 to 40 μm.

In the magnet material described in JP 2002-57017 A, in a case where the proportion of SmFe₉N_{w} (1≤w≤2) serving as a main phase is low and the proportion of a soft magnetic phase or a non-magnetic phase is high, the magnetic properties might deteriorate.

An object of the present invention is to provide a magnetic powder having enhanced magnetic properties, a compound for a bonded magnet, and a bonded magnet.

### SUMMARY OF THE INVENTION

It is an object of the present invention to at least partially solve the problems in the conventional technology.

The magnetic powder of the one aspect of the present disclosure comprises Sm, Zr, Fe, B, and N, wherein an atomic ratio of a content of Zr to a sum of a content of Sm and the content of Zr is greater than 0.10 and smaller than 0.30, and a content of B is greater than 0.0 atom % and smaller than 0.4 atom %.

The compound for a bonded magnet of the one aspect of the present disclosure comprises the magnetic powder and a binder.

The bonded magnet of the one aspect of the present disclosure comprises the compound for a bonded magnet.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic cross-sectional view illustrating a particle cross-section of a magnetic powder according to the present embodiment;

FIG. 2 is a view illustrating a relationship between a remanence B_{rE} calculated using a regression equation and a measured remanence Bᵣ;

FIG. 3 is a view illustrating an SEM image illustrating a cross section in the vicinity of a free surface of the particle according to FIG. 1;

FIG. 4 is a view illustrating an SEM image illustrating a cross section in the vicinity of a wheel-side surface of the particle according to FIG. 1; and

FIG. 5 is a graph illustrating a relationship between a Remanence Bᵣ and a Coercivity H_{cj} according to Examples 1 to 7 and Comparative Examples 1 to 6 and 8.

### DETAILED DESCRIPTION OF THE PREFERRED EMBODIMENTS

Hereinafter, embodiments according to the present disclosure will be described. Note that the invention according to the present disclosure is not limited to these embodiments. The numerical value includes the rounding range. Note that the upper limit and the lower limit of the numerical range according to the following description can be appropriately combined.

### Magnetic Powder

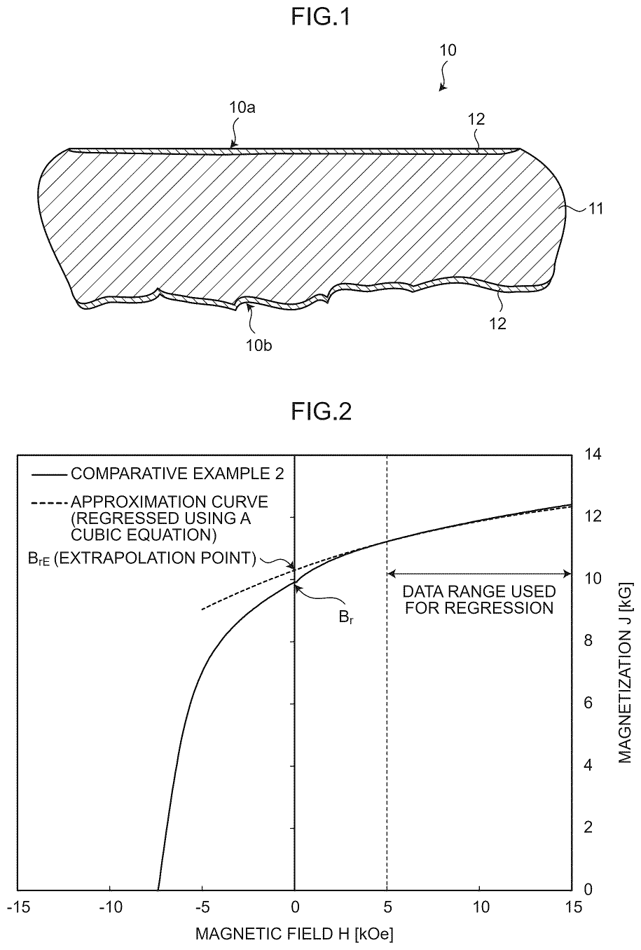

FIG. 1 is a schematic cross-sectional view illustrating a particle cross-section of a magnetic powder according to the present embodiment. The magnetic powder according to the present embodiment is a powder containing a Sm—Fe—N-based isotropic magnetic material. That is, the magnetic powder according to the present embodiment contains a plurality of magnetic powder particles 10, and each magnetic powder particle 10 can be said to be a particle of the Sm—Fe—N-based isotropic magnetic material.

### Composition of Magnetic Powder

Hereinafter, a composition of the magnetic powder of the present embodiment will be described. Note that the composition of the magnetic powder can also be referred to as a composition of each magnetic powder particle 10. The magnetic powder according to the present embodiment contains Sm, Zr, Fe, B, and N.

### Sm

The content of Sm in the magnetic powder is preferably 5.5 atom % or greater and 9.0 atom % or smaller, more preferably greater than 6.0 atom % and smaller than 8.0 atom %, and still more preferably 6.4 atom % or greater and 7.4 atom % or smaller. When the content of Sm satisfies the lower limit of this range, generation of an α-Fe phase can be inhibited, and the remanence of a magnet can be improved. When the content of Sm satisfies the upper limit of this range, the coercivity can be enhanced while a significant decrease in the remanence is mitigated, and a large maximum energy product (BH)ₘₐₓ can be obtained.

### Zr

The content of Zr in the magnetic powder is preferably 0.1 atom % or greater and 3.0 atom % or smaller, more preferably greater than 0.9 atom % and smaller than 2.6 atom %, and still more preferably 1.0 atom % or greater and 2.2 atom % or smaller. When the content of Zr is within this range, the squareness and the remanence are increased, and the maximum energy product (BH)ₘₐₓ can be increased.

$$Zr / ( Sm + Zr )$$

An atomic ratio Zr/(Sm+Zr) of the content of Zr to the sum of the content of Sm and the content of Zr in the magnetic powder is preferably greater than 0.10 and smaller than 0.30, and more preferably 0.15 or greater and 0.20 or smaller. When the atomic ratio Zr/(Sm+Zr) satisfies the lower limit of this range, the stability of the crystal structure of the SmFe₉N_{w} (1≤w≤2) phase serving as the main phase can be improved, and the Remanence Bᵣ can be improved. When the atomic ratio Zr/(Sm+Zr) satisfies the upper limit of this range, deterioration of magnetic properties can be minimized.

### B

The content of B in the magnetic powder is preferably greater than 0.0 atom % and smaller than 0.4 atom %. The content of B in the magnetic powder is more preferably 0.1 atom % or greater and 0.3 atom % or smaller, and still more preferably 0.1 atom % or greater and 0.2 atom % or smaller. When the content of B satisfies the lower limit of this range, the crystal grains are refined, the coercivity can be enhanced, and the magnetic properties can be improved. When the content of B satisfies the upper limit of this range, a decrease in the content of nitrogen can be minimized to improve producibility, the remanence can be improved, and magnetic properties can be improved.

### N

The content of N in the magnetic powder is preferably 10 atom % or greater and 20 atom % or smaller, more preferably greater than 11 atom % and smaller than 15.0 atom %, and still more preferably 12.0 atom % or greater and 14 atom % or smaller. When the content of N is within this range, the remanence can be improved, and the coercivity can also be enhanced.

### B/Zr

An atomic ratio B/Zr of the content of B to the content of Zr in the magnetic powder is preferably 0.01 or greater and 0.20 or smaller, more preferably 0.04 or greater and 0.15 or smaller, and still more preferably 0.05 or greater and 0.10 or smaller. When the atomic ratio B/Zr is within this range, the magnetic properties can be more suitably enhanced.

### Other Components

The magnetic powder may contain a metal M other than Sm, Zr, and Fe. The metal M may be, for example, at least one of Co, Ti, V, Ta, Mo, W, Mn, Ni, Zn, Al, Hf, Si, and Ge. Note that the metal M is not a necessary component, and the magnetic powder may not contain the metal M.

The content of Co in the magnetic powder is preferably 10 atom % or smaller, more preferably 2 atom % or greater and 8 atom % or smaller, and still more preferably 4 atom % or greater and 6 atom % or smaller. When the content of Co satisfies the lower limit of this range, the magnetic properties can be enhanced, and the Curie point can be increased to enhance the high heat resistance. When the content of Co satisfies the upper limit of this range, it is possible to minimize a decrease in the remanence and to reduce the production cost.

The balance of the magnetic powder is preferably Fe and inevitable impurities. In the present disclosure, the inevitable impurities refer to elements having a content of smaller than 0.1 atom %.

As described above, the magnetic powder according to the present embodiment contains Sm, Zr, Fe, B, and N. The atomic ratio of the content of Zr to the sum of the content of Sm and the content of Zr is greater than 0.10 and smaller than 0.30. The content of B is greater than 0.0 atom % and smaller than 0.4 atom %. As a result, the magnetic properties can be enhanced.

The magnetic powder according to the present embodiment contains 5.5 atom % or greater and 9.0 atom % or smaller of Sm, 0.1 atom % or greater and 3.0 atom % or smaller of Zr, greater than 0.0 atom % and smaller than 0.4 atom % of B, 10 atom % or greater and 20 atom % or smaller of N, and 10 atom % or smaller of the metal M, with the balance being Fe and inevitable impurities. The atomic ratio of the content of Zr to the sum of the content of Sm and the content of Zr is greater than 0.10 and smaller than 0.30. The metal M is, for example, at least one of Co, Ti, V, Ta, Mo, W, Mn, Ni, Zn, Al, Hf, Si, and Ge. As a result, the magnetic properties can be enhanced.

Note that the composition of the magnetic powder according to the present embodiment can be measured by inductively coupled plasma (ICP) emission spectrometry for elements other than N, and can be measured by an inert gas fusion-thermal conductivity method for N.

Magnetic Properties of Magnetic Powder The maximum energy product (BH)ₘₐₓ of the magnetic powder according to the present embodiment is preferably greater than 18.5 MGOe, and more preferably 18.7 MGOe or greater. Within this range, enhanced magnetic properties can be obtained. Note that 18.5 MGOe can be expressed as 147 KJ/m³ in the SI system. The same applies to the expressions in the following embodiments.

The Remanence Bᵣ (KG) and the Coercivity H_{cj} (kOe) of the magnetic powder according to the present embodiment preferably satisfy the following Expression (1).

$${B}_{r} \geq - 0.08 {H}_{cj} + 10.6 \qquad ( 1 )$$

By satisfying the above-described Expression (1), it can be said that the Remanence Bᵣ and the Coercivity H_{cj} are large, so that the maximum energy product (BH)ₘₐₓ of the magnetic powder can be increased, thereby obtaining enhanced magnetic properties. Note that the above expression (1) can be expressed in SI units as Br (T)≥−0.0001* H_{cj} (kA/m)+1.06. The same applies to the expressions in the following embodiments.

The knick ratio of the magnetic powder according to the present embodiment is preferably smaller than 0.036, and more preferably 0.033 or smaller. As a result, a decrease in the Remanence Bᵣ can be minimized, the maximum energy product (BH)ₘₐₓ of the magnetic powder can be increased, and enhanced magnetic properties can be obtained.

FIG. 2 is a view illustrating a relationship between a remanence B_{rE} calculated using a regression equation and a measured remanence Bᵣ. FIG. 2 shows an example of comparative example 2, which will be described later. In the present disclosure, the knick ratio is a parameter indicating the degree of bending of the magnetization curve in the vicinity of the Remanence Bᵣ. Specifically, the knick ratio can be calculated by the following Expression (2).

$$( Knick ratio ) = [ ( Remanence {B}_{rE} calculated by regression equation ) - ( Remanence {B}_{r} ) ] / ( Remanence {B}_{rE} calculated by regression equation ) \qquad ( 2 )$$

The Remanence B_{rE} calculated by the regression equation according to Expression (2) is calculated by the extrapolation of the regression equation. Specifically, as shown on the FIG. 2, a magnetization J in the magnetic field of +5 kOe to +15 koe in the magnetization curve was regressed by a cubic expression, and the magnetic flux density in the magnetic field of 0 kOe calculated using the obtained regression expression was defined as the Remanence B_{rE}. The cause of the knick may be the presence of soft magnetic phases in the magnetic powder, other than the main phase, SmFe₉N_{w}. The remanence B_{rE}, calculated by using a regression equation, approximates the residual magnetization that would be obtained without the performance degradation caused by soft magnetic phases. The knick ratio, calculated from B_{rE} and Bᵣ, serves as an indicator of the extent to which performance is degraded by soft magnetic phases. In case that the knick ratio is low, it can be deduced that the magnetic powder contains few phases with low properties and high-quality magnetic powder has been obtained. The Knick ratio can be controlled by adjusting the Sm, Zr and B contents in the magnetic powder.

Here, the maximum energy product (BH)ₘₐₓ, the Remanence Bᵣ, and the Coercivity H_{cj} of the magnetic powder can be measured with a vibrating sample magnetometer (VSM).

The thickness of the magnetic powder particles is preferably 8 μm or greater and 24 μm or smaller, and more preferably 10 μm or greater and 20 μm or smaller. When the thickness of the magnetic powder particles satisfies the lower limit value of this range, the specific surface area can be reduced, and a decrease in the magnetic flux density due to oxidation can be minimized. When the thickness of the magnetic powder particles satisfies the upper limit value of this range, nitriding can be performed satisfactorily, and the coercivity can be enhanced. Note that the thickness of the magnetic powder particles can be measured with a laser displacement meter. More specifically, at least 50 particles collected and obtained from the magnetic powder are taken out, the length in the thickness direction, that is, the direction in which the length is the smallest is measured with a laser displacement meter, and the arithmetic average thereof is calculated; thereby, the thickness of the magnetic powder particles can be measured.

### Crystalline Phases of Magnetic Powder

As illustrated in FIG. 1, at least some of the magnetic powder particles 10 contained in the magnetic powder according to the present embodiment preferably contain a hard magnetic phase 11 and a soft magnetic phase 12. The hard magnetic phase 11 is a phase having a TbCu₇-type structure (crystallographic point group P6/mmm), and is, for example, a SmFe₉N_{w} (1≤w≤2) phase. The soft magnetic phase 12 is a phase having a body-centered cubic lattice structure (crystallographic point group Im3m), and is, for example, an α-Fe phase. In the present embodiment, as illustrated in FIG. 1, in the magnetic powder particles 10, the soft magnetic phase 12 is provided to cover both a free surface 10a and a wheel-side surface 10b of the hard magnetic phase. The presence or absence of the hard magnetic phase 11 and the soft magnetic phase 12 can be determined by observing a particle cross-section of the magnetic powder with a scanning electron microscope (SEM).

In the present disclosure, the wheel-side surface 10b is a surface of a ribbon that has been brought into contact with a cooling wheel in a step of cooling the magnetic powder described later. The free surface 10a is a surface of the ribbon opposite to the wheel-side surface. In the present embodiment, at least some of the magnetic powder particles 10 contained in the magnetic powder may have surfaces constituting at least one of the free surface 10a or the wheel-side surface 10b. That is, the magnetic powder may contain, at one surface thereof, the magnetic powder particles 10, some of which have surfaces constituting the free surface 10a. In addition, the magnetic powder may contain, at one surface thereof, the magnetic powder particles 10, some of which have surfaces constituting the wheel-side surface 10b. In addition, the magnetic powder may contain the magnetic powder particles 10 constituting the free surface 10a at one surface and constituting the wheel-side surface 10b at the other surface. Note that the free surface 10a and the wheel-side surface 10b are not necessary components for the magnetic powder particles 10, and the magnetic powder particles 10 may not constitute the free surface 10a or the wheel-side surface 10b.

### Content of Soft Magnetic Phase

In the present embodiment, the content of the soft magnetic phase 12 in the magnetic powder particles 10 is preferably greater than 0.0 volume % and smaller than 1.0 volume %, more preferably 0.1 volume % or greater and 0.9 volume % or smaller, and still more preferably 0.2 volume % or greater and 0.8 volume % or smaller. When the content of the soft magnetic phase 12 satisfies the lower limit of this range, the crystal structure of the hard magnetic phase 11 can be stabilized, so that magnetic properties can be enhanced. When the content of the soft magnetic phase 12 satisfies the upper limit of this range, deterioration of the magnetic properties due to the soft magnetic phase 12 can be minimized.

The content of the soft magnetic phase 12 can be measured by observing five fields of view of particle cross-sections of the magnetic powder particles 10 at a magnification of 50000 using SEM, acquiring SEM observation images of the particle cross-sections of the magnetic powder particles 10, acquiring a ratio of an area occupied by the soft magnetic phase 12 in the observation images to an area of the entire particle cross-section of the magnetic powder, and converting the ratio into a volume ratio. Similarly, the content of the soft magnetic phase 12 present at the free surface 10a and the wheel-side surface 10b can also be determined by acquiring SEM observation images of particle cross-sections of the magnetic powder particles 10, acquiring a ratio of an area occupied by the soft magnetic phase 12 present at each of the free surface 10a and the wheel-side surface 10b in the observation images to an area of the entire particle cross-section of the magnetic powder particles 10, and converting the ratio into a volume ratio.

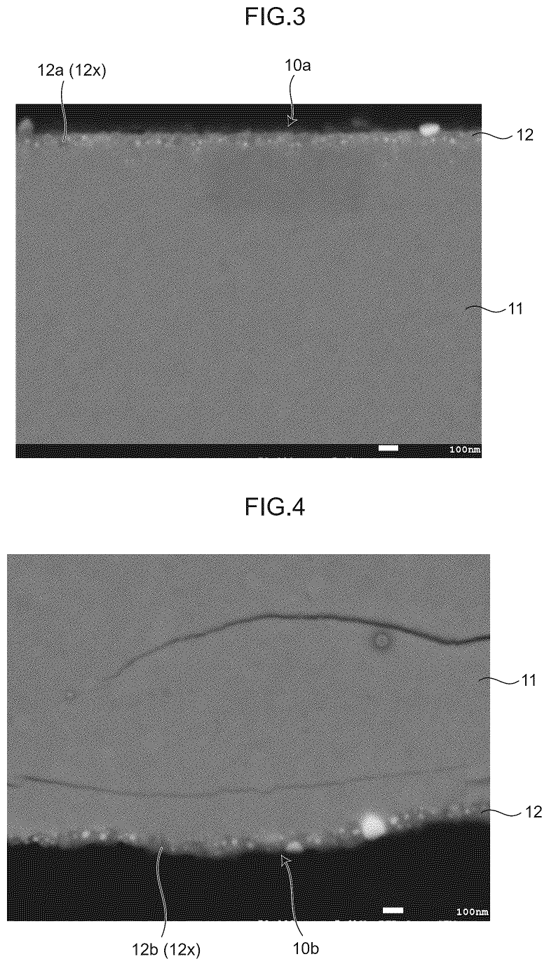

FIG. 3 is a view illustrating an SEM image illustrating a cross section in the vicinity of the free surface of the particle according to FIG. 1. FIG. 4 is a view illustrating an SEM image illustrating a cross section in the vicinity of the wheel-side surface of the particle according to FIG. 1. As illustrated in FIGS. 3 and 4, the soft magnetic phase 12 of the magnetic powder particles 10 includes crystal grains 12x of an α-Fe phase. Hereinafter, among the crystal grains 12x of the α-Fe phase, the crystal grains 12x located at the free surface 10a are defined as crystal grains 12a, and the crystal grains 12x located at the wheel-side surface 10b are defined as crystal grains 12b.

### Size of Soft Magnetic Phase

In the present embodiment, an average size σ of the crystal grains 12x of the α-Fe phase contained in the soft magnetic phase 12 is preferably greater than 30 nm and 500 nm or smaller, more preferably greater than 30 nm and 300 nm or smaller, and still more preferably greater than 30 nm and 200 nm or smaller. The average size of the crystal grains 12a at the free surface 10a is preferably greater than 30 nm and 200 nm or smaller, more preferably greater than 30 nm and 150 nm or smaller, and still more preferably greater than 30 nm and 100 nm or smaller. The average size of the crystal grains 12b at the wheel-side surface 10b is preferably greater than 30 nm and 500 nm or smaller, more preferably greater than 30 nm and 300 nm or smaller, and still more preferably greater than 30 nm and 200 nm or smaller. When the average size of the crystal grains 12x of the α-Fe phase satisfies the lower limit of this range, the producibility of the magnetic powder can be improved. When the average size of the crystal grains 12x of the α-Fe phase satisfies the upper limit of this range, the reinforcing action of the residual magnetism can be enhanced and a decrease in the coercivity of the magnetic powder can be minimized.

In addition, the ratio of the average size of the crystal grains 12b at the wheel-side surface 10b to the average size of the crystal grains 12a at the free surface 10a is preferably 1 or greater and 5 or smaller, and more preferably 1 or greater and 2 or smaller. When the ratio of the size of the crystal grains 12a to the size of the crystal grains 12b is within this range, the reinforcing action of the residual magnetism can be enhanced, and a decrease in the coercivity of the magnetic powder can be minimized.

In the present disclosure, the average size σ of the crystal grains of the α-Fe phase can be measured based on a cross-sectional structure image of the magnetic powder particles 10 acquired by an electron microscope such as an SEM. Specifically, a total cross-sectional area S of n crystal grains of the α-Fe phase is measured from the cross-sectional structure image. Then, the diameter of a circle obtained by calculating the total cross-sectional area S as the sum of the areas of n circles can be determined as the average size σ of the crystal grains of the α-Fe phase. That is, the average size σ of the crystal grains of the α-Fe phase can be calculated by the following Expression (3) using the circle constant π. Here, in view of statistical accuracy and a measurement situation, the number n of crystal grains is 50 or greater.

$$σ = 2 \sqrt{\frac{S}{π n}} \qquad ( 3 )$$

### Thickness of Soft Magnetic Phase

In the present embodiment, the thickness of the soft magnetic phase 12 is preferably 30 nm or greater and 500 nm or smaller, more preferably 30 nm or greater and 300 nm or smaller, and still more preferably 30 nm or greater and 200 nm or smaller. In addition, the thickness of the soft magnetic phase 12 at the free surface 10a is preferably 30 nm or greater and 200 nm or smaller, more preferably 30 nm or greater and 150 nm or smaller, and still more preferably 30 nm or greater and 100 nm or smaller. The thickness of the soft magnetic phase 12 at the wheel-side surface 10b is preferably 30 nm or greater and 500 nm or smaller, more preferably 30 nm or greater and 300 nm or smaller, and still more preferably 30 nm or greater and 200 nm or smaller. When the thickness of the soft magnetic phase 12 is within this range, the reinforcing action of the residual magnetism can be enhanced, and a decrease in the coercivity of the magnetic powder can be minimized.

In addition, the ratio of the thickness of the soft magnetic phase 12 at the wheel-side surface 10b to the thickness of the soft magnetic phase 12 at the free surface 10a is preferably 1 or greater and 10 or smaller, and more preferably 1 or greater and 5 or smaller. When ratio between the thicknesses of the soft magnetic phase 12 is within this range, the reinforcing action of the residual magnetism can be enhanced, and a decrease in the coercivity of the magnetic powder can be minimized.

In the present disclosure, the thickness of the soft magnetic phase 12 can be measured based on the cross-sectional structure image of the magnetic powder particles 10 acquired by an electron microscope such as an SEM.

Note that the magnetic powder particles 10 can have crystalline phases as defined above through appropriate adjustment of the composition thereof and the conditions for producing the magnetic powder.

### Method for Producing Magnetic Powder

A method for producing a magnetic powder according to the present embodiment includes a melting step, a rapid cooling step, a heat treatment step, and a nitriding step. Note that the method for producing a magnetic powder described in the present embodiment is merely an example, and the present embodiment is not limited thereto.

In the melting step, raw materials containing Sm, Zr, Fe, the metal M, and B are blended and melted to prepare a molten metal. Specifically, the raw material powder is melted by high-frequency induction heating in an inert atmosphere such as argon atmosphere to prepare a molten metal.

In the rapid cooling step, the molten metal is ejected onto a rotating cooling wheel to be rapidly cooled. In the rapid cooling step, the molten metal is ejected onto the cooling wheel to form a ribbon. The cooling wheel is, for example, a wheel made of metal such as copper. Here, the speed of the cooling wheel is not particularly limited, but is preferably 20 m/s or greater and 100 m/s or smaller. As a result, the generation of the hard magnetic phase 11 having the TbCu₇-type structure can be promoted, and the magnetic properties can be improved. In this case, among surfaces of the ribbon, the surface in contact with the cooling wheel is a wheel-side surface, and the surface opposite to the wheel-side surface is a free surface. Here, the wheel-side surface reflects the irregularities of the cooling wheel-side surface, whereas the free surface is relatively smoother than the wheel-side surface because the free surface is not brought into contact with the cooling wheel. Thereafter, the ribbon is pulverized to obtain a flake-shaped powder.

In the heat treatment step, the powder obtained in the rapid cooling step is heat-treated in an inert atmosphere at a temperature in a range of 500° C. or higher and 900° C. or lower. The inert atmosphere is, for example, argon atmosphere.

In the nitriding step, the powder subjected to the heat treatment step is nitrided by heating in a gas containing molecules containing a nitrogen atom. Specifically, the powder is charged into a tubular furnace, and a gas containing molecules containing nitrogen atom % is caused to flow into the tubular furnace to perform nitriding. As the gas containing molecules containing a nitrogen atom, for example, a nitrogen gas, a mixed gas of ammonia and hydrogen, or the like is preferably used. Here, the pressure and the heating temperature of the gas used in the nitriding treatment step are adjusted according to the gas to be used. In a specific example, when nitrogen gas is used, the heating temperature is set to 400° C. to 500° C. In addition, the content of N in the powder is adjusted through adjustment of the time of the nitriding treatment. Note that, in a case where the amount of the powder is large, it is preferable to perform nitriding while stirring the powder in a rotary heating furnace in order to improve the uniformity of a product and the efficiency of the reaction.

By the above operation, the magnetic powder according to the present embodiment is obtained.

### Compound for Bonded Magnet

A compound for a bonded magnet according to the present embodiment contains the magnetic powder according to the present embodiment and a binder. Accordingly, it is possible to provide a compound for a bonded magnet having enhanced magnetic properties.

The compound for a bonded magnet according to the present embodiment can be produced by, for example, mixing the powder of the magnetic powder according to the present embodiment and the powder of the binder.

The binder is a material that binds the magnetic powder particles to one another. The type of the binder is not particularly limited, and for example, a phenol resin, an epoxy resin, nylon, or the like can be used. Here, in a case where the compound for a bonded magnet is used for producing a bonded magnet produced by compression molding, the binder is preferably a thermosetting resin such as a phenol resin or an epoxy resin. On the other hand, in a case where the compound for a bonded magnet is used for producing a bonded magnet produced by injection molding, the binder is preferably a thermoplastic resin such as nylon.

### Bonded Magnet

A bonded magnet according to the present embodiment contains the compound for a bonded magnet according to the present embodiment. Accordingly, it is possible to provide a bonded magnet having enhanced magnetic properties.

A method for producing the bonded magnet according to the present embodiment is not particularly limited, and for example, the bonded magnet can be produced by a molding step and a magnetization step.

In the molding step, the compound for a bonded magnet is molded by compression molding, injection molding, or the like. In a case where the bonded magnet is produced by compression molding, the compound for a bonded magnet is placed in a press mold, a molded body is obtained by compression molding, and the molded body is heated in an inert atmosphere such as nitrogen atmosphere to cure the binder. Here, the compression molding for obtaining the molded body can be performed at a pressure of, for example, 10 t/cm², and the molded body can be heated at a heating temperature of, for example, 150° C. for a heating time of one hour.

In the magnetization step, an external magnetic field is applied to the molded body to magnetize the molded body. Accordingly, the bonded magnet according to the present embodiment can be produced.

### EXAMPLES

Hereinafter, examples according to the present embodiment will be described. Note that the following examples do not limit the invention according to the present disclosure.

Table 1 is a table illustrating compositions, production conditions, and magnetic properties of magnetic powders according to Examples 1 to 7 and Comparative Examples 1 to 8.

TABLE 1

| | | | | | | | | | Magnetic properties | | | |
|---|---|---|---|---|---|---|---|---|---|---|---|---|
| | | | | | | | | Heat | | | Maximum | |
| | | | | | | | | treatment | | | energy | |
| | Composition (atom %) | | | | | | Zr/(Sm + Zr) | temperature | Remanence | Coercivity | product | Knick |
| | Sm | Zr | Fe | Co | B | N | (atomic ratio) | (° C.) | Bᵣ(kG) | H_{cj}(kOe) | (BH)ₘₐₓ(MGOe) | ratio |
| Example 1 | 7.3 | 1.3 | 74.6 | 4.0 | 0.1 | 12.4 | 0.15 | 740 | 9.8 | 10.6 | 19.7 | 0.020 |
| Example 2 | 6.9 | 1.7 | 74.3 | 4.0 | 0.1 | 12.7 | 0.20 | 740 | 9.9 | 9.5 | 19.2 | 0.025 |
| Example 3 | 6.4 | 2.2 | 74.6 | 4.0 | 0.1 | 12.5 | 0.25 | 740 | 10.0 | 8.5 | 18.7 | 0.033 |
| Example 4 | 7.3 | 1.3 | 74.6 | 4.0 | 0.1 | 12.4 | 0.15 | 760 | 9.7 | 12.1 | 19.6 | 0.026 |
| Example 5 | 6.9 | 1.7 | 74.4 | 4.0 | 0.1 | 12.6 | 0.20 | 760 | 9.8 | 10.9 | 19.4 | 0.027 |
| Example 6 | 6.5 | 2.2 | 74.9 | 4.0 | 0.1 | 12.0 | 0.25 | 760 | 9.8 | 10.2 | 19.0 | 0.030 |
| Example 7 | 7.4 | 1.0 | 74.6 | 3.9 | 0.2 | 12.5 | 0.12 | 740 | 9.8 | 10.3 | 19.2 | 0.031 |
| Comparative | 7.6 | 0.9 | 74.7 | 4.0 | 0.1 | 12.4 | 0.10 | 740 | 9.7 | 10.7 | 18.5 | 0.040 |
| Example 1 | | | | | | | | | | | | |
| Comparative | 6.0 | 2.6 | 74.5 | 4.0 | 0.1 | 12.5 | 0.30 | 740 | 9.9 | 7.5 | 17.0 | 0.044 |
| Example 2 | | | | | | | | | | | | |
| Comparative | 7.6 | 0.9 | 74.9 | 4.0 | 0.1 | 12.0 | 0.10 | 760 | 9.5 | 12.1 | 18.0 | 0.040 |
| Example 3 | | | | | | | | | | | | |
| Comparative | 6.0 | 2.6 | 74.9 | 4.0 | 0.1 | 12.1 | 0.30 | 760 | 9.8 | 9.4 | 18.2 | 0.036 |
| Example 4 | | | | | | | | | | | | |
| Comparative | 7.4 | 1.0 | 74.2 | 4.0 | 0.0 | 13.2 | 0.12 | 740 | 9.4 | 10.3 | 17.5 | 0.040 |
| Example 5 | | | | | | | | | | | | |
| Comparative | 7.4 | 1.0 | 74.4 | 4.0 | 0.0 | 13.0 | 0.12 | 780 | 9.0 | 12.6 | 16.3 | 0.040 |
| Example 6 | | | | | | | | | | | | |
| Comparative | 7.8 | 1.1 | 81.3 | 4.2 | 0.4 | 5.1 | 0.13 | 740 | 7.9 | 2.8 | 5.1 | 0.158 |
| Example 7 | | | | | | | | | | | | |
| Comparative | 7.5 | 1.1 | 78.3 | 4.1 | 0.4 | 8.6 | 0.13 | 780 | 7.9 | 10.2 | 6.8 | 0.143 |
| Example 8 | | | | | | | | | | | | |

### Examples 1 to 7 and Comparative Examples 1 to 8

Examples 1 to 7 and Comparative Examples 1 to 8 were prepared by the method described in the above embodiment. That is, the powders according to Examples 1 to 7 and Comparative Examples 1 to 8 were prepared by the melting step, the rapid cooling step, the heat treatment step, and the nitriding step.

In Examples 1 to 7 and Comparative Examples 1 to 4, 7, and 8, in the melting step, Sm, Zr, Fe, Co, and B were blended and melted to have the composition illustrated in Table 1 to prepare molten metals. In Comparative Examples 5 and 6, in the melting step, raw materials containing Sm, Zr, Fe, and Co were blended and melted to prepare molten metals. That is, in Comparative Examples 5 and 6, B was not added. The molten metals were prepared by charging the raw materials into a quartz nozzle having pores with a diameter of 0.5 mm at the bottom, and melting the raw material by high-frequency induction heating in an argon atmosphere.

In the rapid cooling step, ribbons were formed by ejecting molten metals onto a rotating cooling wheel. Thereafter, the ribbons were pulverized to obtain flake-shaped powders. Then, the flake-shaped powders were sieved through a sieve with a sieve mesh of about 300 μm to collect the powder obtained.

In the heat treatment step, the powders obtained in the rapid cooling step were heat-treated at the heat treatment temperatures illustrated in Table 1 for 60 minutes under argon atmosphere.

In the nitriding step, the powders subjected to the heat treatment step were nitrided by heating at 440° C. for 15 hours under nitrogen gas atmosphere.

For the prepared magnetic powders, as the magnetic properties, the Remanence Bᵣ, the Coercivity H_{cj}, the maximum energy product (BH)ₘₐₓ, and the knick ratio were measured by VSM. Here, in the measurement of the magnetic properties, the average true density of the magnetic powder particles was set to 7.66 g/cm³.

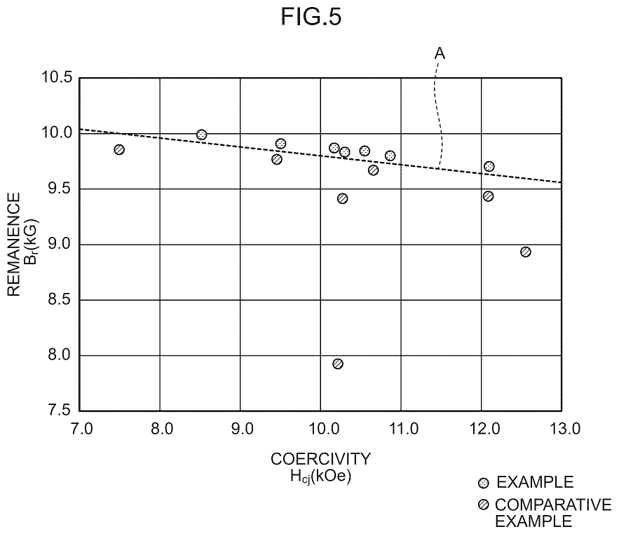

The magnetic properties of the materials according to Examples 1 to 7 and Comparative Examples 1 to 8 are illustrated in Table 1 and FIG. 5. FIG. 5 is a graph illustrating the relationship between the Remanence Bᵣ and the Coercivity H_{cj} according to Examples 1 to 7 and Comparative Examples 1 to 6 and 8. In FIG. 5, the data of Comparative Example 7 is not illustrated because the Coercivity H_{cj} is small. In addition, line A illustrated in FIG. 5 represents the following Expression (4).

$${B}_{r} \geq - 0.08 {H}_{cj} + 10.6 \qquad ( 4 )$$

That is, in FIG. 5, line A and a region above line A are regions satisfying the following Expression (1).

$${B}_{r} \geq - 0.08 {H}_{cj} + 10.6 \qquad ( 1 )$$

As illustrated in Table 1, in Examples 1 to 7, the atomic ratios Zr/(Sm+Zr) are greater than 0.10 and smaller than 0.30, whereas in Comparative Examples 1 and 3, the atomic ratios Zr/(Sm+Zr) are 0.10 or smaller, and in Comparative Examples 2 and 4, the atomic ratios Zr/(Sm+Zr) are 0.30 or greater. Regarding the relationship between the Remanence Bᵣ and the Coercivity H_{cj}, as illustrated in FIG. 5, the plots according to Examples 1 to 7 are located above line A and satisfy Expression (1), whereas the plots according to Comparative Examples 1 to 4 are located below line A and do not satisfy Expression (1). In addition, as illustrated in Table 1, the maximum energy products (BH)ₘₐₓ according to Examples 1 to 7 were greater than 18.5 MGOe, whereas the maximum energy products (BH)ₘₐₓ according to Comparative Examples 1 to 4 were 18.5 MGOe or smaller. Furthermore, as illustrated in Table 1, while the knick ratios according to Examples 1 to 7 were smaller than 0.036, the knick ratios according to Comparative Examples 1 to 4 were 0.036 or greater. Accordingly, it has been found that when the atomic ratio Zr/(Sm+Zr) is greater than 0.10 and smaller than 0.30, magnetic properties can be enhanced.

As illustrated in Table 1, in Examples 1 to 5, the atomic ratios Zr/(Sm+Zr) are 0.15 or greater and 0.20 or smaller, whereas in Example 6, the atomic ratio Zr/(Sm+Zr) is greater than 0.20, and in Example 7, the atomic ratio Zr/(Sm+Zr) is smaller than 0.15. In addition, as illustrated in Table 1, the maximum energy products (BH)ₘₐₓ according to Examples 1 to 5 are greater than the maximum energy products (BH)ₘₐₓ according to Examples 6 and 7. Accordingly, it has been found that when the atomic ratio Zr/(Sm+Zr) is 0.15 or greater and 0.20 or smaller, the magnetic properties can be further enhanced.

As illustrated in Table 1, in each of Examples 1 to 7, the content of B is greater than 0.0 atom % and smaller than 0.4 atom, whereas in each of Comparative Examples 5 and 6, the content of B is 0.0 atom % or smaller, and in each of Comparative Examples 7 and 8, the content of B is 0.4 atom % or greater. Regarding the relationship between the Remanence Bᵣ and the Coercivity H_{cj}, as illustrated in FIG. 5, the plots according to Examples 1 to 7 are located above line A and satisfy Expression (1), whereas the plots according to Comparative Examples 5 to 8 are located below line A and do not satisfy Expression (1). In addition, as illustrated in Table 1, the maximum energy products (BH)ₘₐₓ according to Examples 1 to 7 were greater than 18.5 MGOe, whereas the maximum energy products (BH)ₘₐₓ according to Comparative Examples 5 to 8 were 18.5 MGOe or smaller. Furthermore, as illustrated in Table 1, while the knick ratios according to Examples 1 to 7 were smaller than 0.036, the knick ratios according to Comparative Examples 5 to 8 were 0.036 or greater. Accordingly, it has been found that when the content of B is greater than 0.0 atom % and smaller than 0.4 atom %, magnetic properties can be enhanced.

As illustrated in Table 1, in each of Examples 1 to 7, the content of B is 0.1 atom % or greater and 0.3 atom % or smaller, whereas in each of Comparative Examples 5 and 6, the content of B is smaller than 0.1 atom %, and in each of Comparative Examples 7 and 8, the content of B is greater than 0.3 atom %. As illustrated in Table 1, the maximum energy products (BH)ₘₐₓ according to Examples 1 to 7 were greater than the maximum energy products (BH)ₘₐₓ according to Comparative Examples 5 to 8. In addition, as illustrated in Table 1, the knick ratios according to Examples 1 to 7 were smaller than the knick ratios according to Comparative Examples 5 to 8. Accordingly, it has been found that when the content of B is 0.1 atom % or greater and 0.3 atom % or smaller, magnetic properties can be enhanced.

The invention according to the present disclosure is not limited to the above-described embodiment, and modifications can be made within the scope of the gist of the invention according to the present disclosure.

Note that the present embodiment may have the following aspects.

The magnetic powder of a first aspect comprises Sm, Zr, Fe, B, and N, wherein an atomic ratio of a content of Zr to a sum of a content of Sm and the content of Zr is greater than 0.10 and smaller than 0.30, and a content of B is greater than 0.0 atom % and smaller than 0.4 atom %.

In the magnetic powder of a second aspect according to the first aspect, the atomic ratio is 0.15 or greater and 0.20 or smaller.

In the magnetic powder of a third aspect according to the first or second aspect, the content of B is 0.1 atom % or greater and 0.3 atom % or smaller.

In the magnetic powder of a fourth aspect according to one of the first to third aspect, a maximum energy product is greater than 18.5 MGOe.

In the magnetic powder of a fifth aspect according to one of the first to fourth aspect, a Remanence Bᵣ (kG) and a Coercivity H_{cj} (kOe) satisfy Expression (1) described below,

$${B}_{r} \geq - 0.08 {H}_{cj} + 10.6 . \qquad ( 1 )$$

In the magnetic powder of a sixth aspect according to one of the first to fifth aspect, a knick ratio is smaller than 0.036.

The magnetic powder of a seventh aspect according to one of the first to sixth aspect further comprises at least one of magnetic powder particles containing a hard magnetic phase having a TbCu₇-type structure, and a soft magnetic phase having a body-centered cubic lattice structure.

In the magnetic powder of an eighth aspect according to the seventh aspect, a content of the soft magnetic phase is greater than 0.0 volume % and smaller than 1.0 volume %.

In the magnetic powder of an ninth aspect according to the seventh or eighth aspect, an average size of crystal grains contained in the soft magnetic phase is greater than 30 nm and 500 nm or smaller.

The compound for a bonded magnet of the tenth aspect comprises the magnetic powder according to the first aspect and a binder.

The bonded magnet of the eleventh aspect comprises the compound for a bonded magnet according to the tenth aspect.

According to the present invention, it is possible to provide the magnetic powder having enhanced magnetic properties, the compound for a bonded magnet, and the bonded magnet.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A magnetic powder comprising Sm, Zr, Fe, B, and N, wherein
an atomic ratio of a content of Zr to a sum of a content of Sm and the content of Zr is greater than 0.10 and smaller than 0.30, and
a content of B is greater than 0.0 atom % and smaller than 0.4 atom %.

2. The magnetic powder according to claim 1, wherein the atomic ratio is 0.15 or greater and 0.20 or smaller.

3. The magnetic powder according to claim 1, wherein the content of B is 0.1 atom % or greater and 0.3 atom % or smaller.

4. The magnetic powder according to claim 1, wherein a maximum energy product is greater than 18.5 MGOe.

5. The magnetic powder according to claim 1, wherein a Remanence Bᵣ (kG) and a Coercivity H_{cj} (kOe) satisfy Expression (1) described below,
$${B}_{r} \geq - 0.08 {H}_{cj} + 10.6 . \qquad ( 1 )$$

6. The magnetic powder according to claim 1, wherein a knick ratio is smaller than 0.036.

7. The magnetic powder according to claim 1, further comprising at least one of magnetic powder particles containing
a hard magnetic phase having a TbCu₇-type structure, and
a soft magnetic phase having a body-centered cubic lattice structure.

8. The magnetic powder according to claim 7, wherein a content of the soft magnetic phase is greater than 0.0 volume % and smaller than 1.0 volume %.

9. The magnetic powder according to claim 7, wherein an average size of crystal grains contained in the soft magnetic phase is greater than 30 nm and 500 nm or smaller.

10. A compound for a bonded magnet comprising:
the magnetic powder according to claim 1; and
a binder.

11. A bonded magnet comprising the compound for a bonded magnet according to claim 10.
